(19) United States
(12) Patent Application Publication
(10) Pub. No.: US 2001/0008427 A1
(43) Pub. Date: Jul. 19, 2001

(54) Apparatus and method for supporting picture-in-picture type time shifting

(76) Inventor: Bum Joo Seo, Seoul (KR)

Correspondence Address: BIRCH STEWART KOLASCH & BIRCH, PO BOX 747, FALLS CHURCH, VA, 22040-0747, US

(21) Appl. No.: 09/752,721

(22) Filed: Jan. 3, 2001

(30) Foreign Application Priority Data
Jan. 19, 2000 (KR) 2492/2000

(51) Int. Cl. H04N 5/44; H04N 5/45

(52) U.S. Cl. 348/565; 348/553

(57) ABSTRACT

Disclosed is a method for supporting a picture-in-picture (PIP) type time shifting which enables a live broadcasting picture or a time-shifted SD stream to be viewed simultaneously with a time shifting of another SD stream on a PIP screen. The method includes a first display step of receiving a plurality of broadcasting programs received through a broadcasting network and displaying the respective live broadcasting programs through a PIP structure on a screen, a second display step of selectively storing in a storage section one among the plurality of broadcasting programs displayed at the first display step and selectively reproducing the stored broadcasting program through the time shifting to display the stored broadcasting program on the screen, and a third display step of displaying through the PIP structure on the screen a plurality of currently received other live broadcasting programs simultaneously with the second display step.

### BACKGROUND OF THE INVENTION

1. Field of the Invention

The present invention relates to a time shifting of a digital television receiver, and more particularly to an apparatus and method for supporting picture-in-picture (PIP) type time shifting.

2. Description of the Related Art

Recently, a digital television receiver (TV) has been developed, which directly stores analog data or digital data transmitted through a television broadcasting network in a hard disc drive attached to the digital TV, and reproduces the stored broadcasting data later according to the request of a user.

The leading companies of this field are Tivo, ReplayTV, etc., and a personal video recorder (PVR) proposed by Tivo, ReplayTV, etc., is designed to be able to store broadcasting programs even simultaneously broadcasted from different broadcasting stations for 30 hours at maximum by applying a hard disc to a TV or STB. Thus, it gives a viewer amusement with selecting and viewing desired programs.

Also, a Metabyte TeleVision (MbTV) and so on provides a method of directly receiving broadcasting digital data and storing the data in a hard disc.

Currently, a technique of decoding and providing by a live broadcast four PIP type standard definition (SD, 4˜6 Mbps class) streams at maximum, which are transmitted through one channel, has been implemented by hardware.

However, an apparatus or method for supporting the PIP type time shifting is limited to the decoding of SD streams transmitted through a broadcasting network within one channel. Further, in implementing a time shifting application, any PIP function for simultaneously supporting the reproduction of streams stored in a hard disc drive and a live reproduction of streams transmitted through a broadcasting network has not yet been implemented.

### SUMMARY OF THE INVENTION

Accordingly, the present invention is directed to an apparatus and method for supporting a PIP type time shifting that substantially obviate one or more of the problems due to limitations and disadvantages of the related art.

An object of the present invention is to provide an apparatus and method for supporting a PIP type time shifting which enables a live broadcasting picture or a time-shifted SD stream to be viewed simultaneously with a time shifting of another SD stream on a PIP screen.

Additional features and advantages of the invention will be set forth in the description which follows, and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, the method for supporting a picture-in-picture (PIP) type time shifting comprising a first display step of receiving a plurality of broadcasting programs received through a broadcasting network and displaying the respective live broadcasting programs through a PIP structure on a screen, a second display step of selectively storing in a storage section one among the plurality of broadcasting programs displayed at the first display step and selectively reproducing the stored broadcasting program through the time shifting to display the stored broadcasting program on the screen, and a third display step of displaying through the PIP structure on the screen a plurality of currently received other live broadcasting programs simultaneously with the second display step.

The third display step further comprises the step of removing the picture of the selected broadcasting program reproduced through the time shifting, and displaying the plurality of the currently received live broadcasting programs through the PIP structure.

Also, the third display step further comprises the steps of removing the corresponding live broadcasting program currently received and storing the corresponding live broadcasting program in the storage section, reproducing the stored corresponding broadcasting program, and displaying the currently received live broadcasting program and the reproduced broadcasting program through the PIP structure on the screen.

In another aspect of the present invention, there is provided an apparatus for supporting a PIP type time shifting comprising an NTSC/PAL encoding section for compressing and encoding an analog broadcasting signal received through a broadcasting network, a demux section for selecting one of the analog broadcasting signal outputted from the NTSC/PAL encoding section and a digital broadcasting signal inputted through the broadcasting network, a packet identifier (PID) filter section for filtering a plurality of TP stream packets to discriminate packets which coincide with packet identifiers (PIDs) desired to be recorded, a storage section interface for enabling the TP stream packet selectively filtered through the PID filter section to be stored in a storage device with desired information added thereto and for enabling the desired TP stream among the TP streams stored in the storage device to be searched and read out, and a remux section for supporting a PIP function by selecting the desired stream among the TP stream packets transmitted for a live broadcast or the TP stream packets read out from the storage device and converting the selected stream into the TP stream packets again.

In case of a live PIP reproduction of all the inputted TP stream packets, the PID filter section, the storage section interface, and the remux section are all defined to be in a disable state. In case of displaying in full only one stream packet selected among the inputted TP stream packets and performing the time shifting, the PID filter section and the storage section interface are defined to be in an enable state, and the remux section is defined to be in a disable state. In case of a PIP reproduction wherein a portion of the TP stream packets is reproduced through the time shifting and the other portion thereof is simultaneously reproduced live, the PID filter section, the storage section interface, and the remux section are all defined to be in an enable state. The PIDs of the TP stream packets have different values from one another.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention:

In the drawings:

FIG. 1 is a view illustrating an example of the change of the PIP screen, full screen, and time shifted screen according to the present invention.

FIG. 2 is a block diagram illustrating the construction for obtaining the time shifted PIP with a remux logic added thereto according to the present invention.

### DETAILED DESCRIPTION OF THE PREFERRED EMBODIMENT

Reference will now be made in detail to the apparatus and method for supporting the PIP type time shifting according to the preferred embodiment of the present invention, examples of which are illustrated in the accompanying drawings.

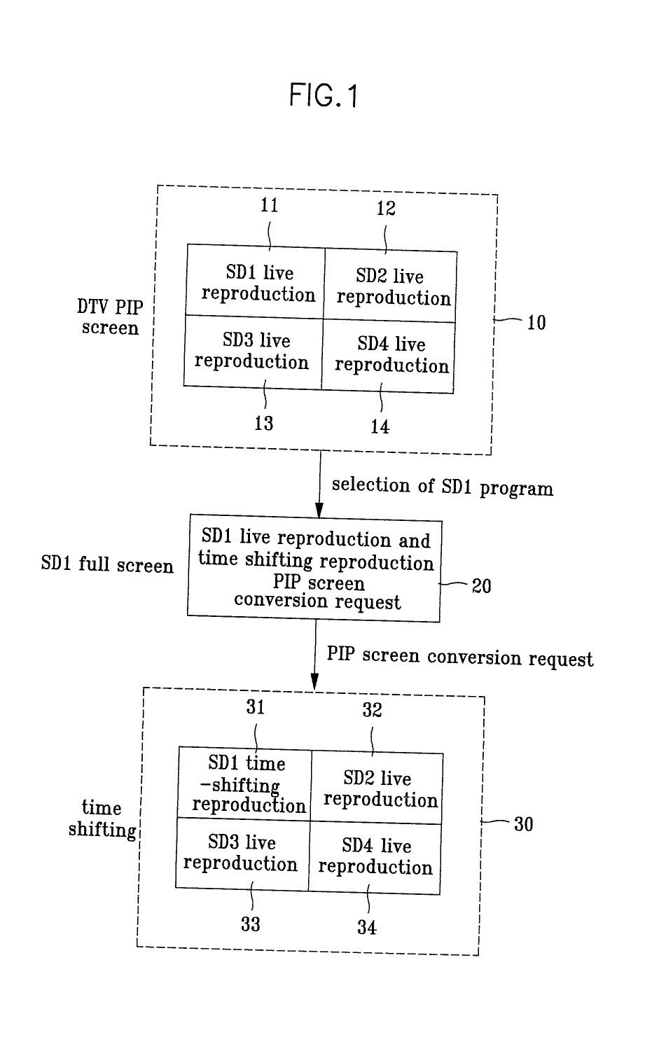

FIG. 1 is a view illustrating an example of the change of the PIP screen, full screen, and time shifted screen according to the present invention.

Referring to FIG. 1, if four SD streams within one channel is transmitted to the digital TV through a broadcasting network, the user can select a PIP screen request through an external input device to simultaneously view the four transmitted SD streams or a portion thereof. Accordingly, the four SD streams ( i.e., SD1 to SD4) 11 to 14 are displayed through the PIP structure on the screen (See “10” in FIG. 1). At this time, only a portion of the four SD streams may be displayed in accordance with the selection of the user.

Then, the user can select the most interesting one among the SD streams as he/she views the SD streams displayed through the PIP structure on the screen. For example, if the user selects SD1, the system converts the PIP screen into a full screen to display the selected SD1 in full on the screen (See “20” in FIG. 1).

While the user views the selected SD1, he/she can perform the time shifting operation. At this time, the time shifting application starts to store an SD1 program in the hard disc drive from the time point where the time shifting starts.

The time shifting operation is performed in accordance with control signals such as a fast rewind, rewind, stop, pause, playback, high-speed playback, etc. inputted through the external input device, and the performance of the high-speed playback is controlled in accordance with the amount of broadcasting data stored in the hard disc drive.

If the user intends to search other SD streams while he/she views the selected SD1 in a full screen, he/she selects a PIP screen conversion button provided in the external input device to perform a screen conversion so that the plurality of SD streams are viewed through the PIP screen.

The construction of the PIP screen is classified into the following two models in accordance with the broadcast of SD1 according to the time shifting operation of SD1.

The first model refers to a method of removing the SD1 picture having a time interval from the currently transmitted broadcasting signal through the time shifting, and simply displaying the four transmitted live broadcasting programs SD1 to SD4.

The second model refers to a method of continuously displaying the SD1 broadcasting program which has been displayed in the full screen at a specified time interval from the currently transmitted broadcasting programs, and displaying the remaining broadcasting programs SD2 to SD4 live.

The first model can be easily implemented without a specific time shifting logic since it functions to simply stop the SD1 program being time-shifted through the hard disc drive and to reproduce the SD1 program being transmitted as a live broadcasting signal.

However, since a specified time difference occurs between the program that the user views as performing a pause and so on and the live broadcasting program, the viewer cannot directly view the program for the time period corresponding to the time difference, but only can view the corresponding portion of the program stored in the hard disc drive later.

The second model can solve the above-described problem involved in the first model since the viewer can view the SD1 program from the position thereof that was viewed before the PIP screen. In order to support the above-described operation, the second model requires a remux logic for the continuous playback of the SD stream currently reproduced in addition to the existing time shifting logic.

By the above described method, four SD programs at maximum can be stored in the hard disc drive through the time shifting, and then reproduced through the PIP screen.

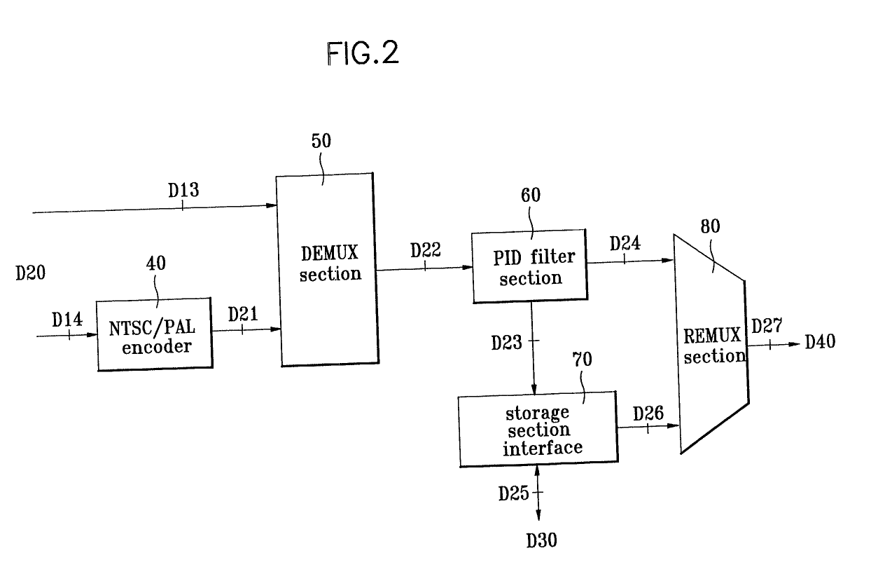

FIG. 2 is a block diagram illustrating the construction for obtaining the time shifted PIP with a remux logic added thereto according to the present invention.

Referring to FIG. 2, the apparatus for supporting a PIP type time shifting according to the present invention includes an NTSC/PAL encoding section 40 for compressing and encoding an analog broadcasting signal received through a broadcasting network, a demux section 50 for selecting one of the analog broadcasting signal outputted from the NTSC/PAL encoding section 40 and a digital broadcasting signal inputted through the broadcasting network, a packet identifier (PID) filter section 60 for filtering a plurality of TP stream packets to discriminate packets which coincide with a packet identifier (PID) desired to be recorded, a storage section interface 70 for enabling the TP stream packet selectively filtered through the PID filter section 60 to be stored in a storage device with desired information rapidly added thereto and for enabling the desired TP stream among the TP streams stored in the storage device to be searched and read out, and a remux section 80 for supporting a PIP function by selecting the desired stream among the TP stream packets transmitted for a live broadcast or the TP stream packets read out from the storage device and converting the selected stream into the TP stream packets again.

The operation of the remux section which is the core element of the present invention will now be explained in detail with reference to FIGS. 1 and 2.

First, in case of the four PIP live reproduction (See“10” in FIG. 1), a processor (not illustrated) makes all the PID filter section 60, the storage section interface 70, and the remux section 80 in the disable state by transferring the control signal to the time shifting logic. At this time, the disabled remux section 80 reproduces the live stream through the PIP screen by bypassing the input stream inputted from the demux section 50 to the PID filter section 60.

Then, one stream SD1 selected among the plurality of PIP pictures in accordance with the request of the user is displayed in full, and in case of performing the time shifting (See “20” in FIG. 1), the PID filter section 60 and the storage section interface 70 are enabled, and the remux section 80 are disabled by the processor (not illustrated).

At this time, the PID filter section 60 filters the time-shifted SD program, transfers the SD program to the storage section interface 70, and stores the SD program in the hard disc drive (not illustrated) through the storage section interface 70. Also, the PID filter section 60 removes the remaining SD programs SD2 to SD4 not filtered.

The SD program SD1 stored in the hard disc drive is read out from the hard disc drive through the bidirectional storage section interface 70, and transferred to the remux section 80. Thus, the SD program filtered by the PID filter section 60 and then stored in the hard disc drive is displayed on the screen (See “20” in FIG. 1).

Next, in case of the PIP reproduction wherein the plural time shifting reproduction and the plural live reproduction are simultaneously processed (See “30” in FIG. 1), the processor makes all the PID filter section 60, the storage section interface 70, and the remux section 80 in the enable state.

In this case, the PID filter section 60 does not remove the SD programs SD2 to SD4 not filtered, but transfers them to the remux section 80 as its input signal. The PID filter section 60 transfers the filtered SD program SD1 to the storage section interface 70, and stores it in the hard disc drive through the storage section interface 70.

The SD program SD1 stored in the hard disc drive is also read out from the hard disc drive through the bidirectional storage section interface 70, and inputted to the remux section 80 as its input signal. Thus, the remux section 80 processes inputs of the live SD programs transferred, not being filtered through the PID filter, and inputs of the stored SD programs read out from the disc through the storage section interface 70, and produces one multiplexed transport stream. At this time, the packet identifiers (PIDs) of the respective SD programs have the values different from one another.

As described above, the present invention can satisfy the viewing desire of the viewer that occurs when the PIP screen for the time shifting of a specified stream is changed to the PIP screen for displaying the live broadcasting programs by employing a separate remux section 80.

The remux section 80 can accommodate four SD stream inputs among stream inputs through the live broadcast and stream inputs through the hard disc drive. The remux section 80 demultiplexes and transfers the four SD stream inputs to the decoding logic.

At this time, the accommodation of four SD stream inputs in total means that the total number of inputs to be reproduced is four, and it makes it a condition that the PIDs of the respective SD streams or the stream identifications (IDs) should be different from one another.

As described above, according to the method for supporting a PIP type time shifting, a live broadcasting picture or a time-shifted SD stream can be viewed simultaneously with a time shifting of another SD stream on a PIP screen.

While the present invention has been described and illustrated herein with reference to the preferred embodiment thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

What is claimed is:

1. A method for supporting a picture-in-picture (PIP) type time shifting comprising:
a first display step of receiving a plurality of broadcasting programs received through a broadcasting network, and displaying the respective live broadcasting programs through a PIP structure on a screen;
a second display step of selectively storing in a storage section one among the plurality of broadcasting programs displayed at the first display step, and selectively reproducing the stored broadcasting program through the time shifting to display the stored broadcasting program on the screen; and
a third display step of displaying through the PIP structure on the screen a plurality of currently received other live broadcasting programs simultaneously with the second display step.

2. The method as claimed in claim 1, the third display step further comprises the step of removing the picture of the selected broadcasting program reproduced through the time shifting, and displaying the plurality of the currently received live broadcasting programs through the PIP structure.

3. The method as claimed in claim 1, wherein the third display step further comprises the steps of:
removing the corresponding live broadcasting program currently received and storing the corresponding live broadcasting program in the storage section;
reproducing the stored corresponding broadcasting program; and
displaying the currently received live broadcasting program and the reproduced broadcasting program through the PIP structure on the screen.

4. An apparatus for supporting a PIP type time shifting comprising:
an NTSC/PAL encoding section for compressing and encoding an analog broadcasting signal received through a broadcasting network;
a demux section for selecting one of the analog broadcasting signal outputted from the NTSC/PAL encoding section and a digital broadcasting signal inputted through the broadcasting network;
a packet identifier (PID) filter section for filtering a plurality of TP stream packets to discriminate packets which coincide with packet identifiers (PIDs) desired to be recorded;
a storage section interface for enabling the TP stream packet selectively filtered through the PID filter section to be stored in a storage device with desired information added thereto, and for enabling the desired TP stream among the TP streams stored in the storage device to be searched and read out; and
a remux section for supporting a PIP function by selecting the desired stream among the TP stream packets transmitted for a live broadcast or the TP stream packets read out from the storage device, and converting the selected stream into the TP stream packets again.

5. The apparatus as claimed in claim 4, wherein in case of a live PIP reproduction of all the inputted TP stream packets, the PID filter section, the storage section interface, and the remux section are all defined to be in a disable state.

6. The apparatus as claimed in claim 4, wherein in case of displaying in full only one stream packet selected among the inputted TP stream packets and performing the time shifting, the PID filter section and the storage section interface are defined to be in an enable state, and the remux section is defined to be in a disable state.

7. The apparatus as claimed in claim 4, wherein in case of a PIP reproduction wherein a portion of the TP stream packets is reproduced through the time shifting and the other portion thereof is simultaneously reproduced live, the PID filter section, the storage section interface, and the remux section are all defined to be in an enable state.

8. The apparatus as claimed in claim 4, wherein the PIDs of the TP stream packets have different values from one another.
